(19) United States
(12) Patent Application Publication
(10) Pub. No.: US 2006/0065996 A1
(43) Pub. Date: Mar. 30, 2006

(54) Method for the production of colored osb plates

(75) Inventors: Juliane Kruesemann, Ludwigshafen (DE); Manfred Siegler, Frankenthal (DE); Andreas Stohr, Freinsheim (DE)

Correspondence Address: OBLON, SPIVAK, MCCLELLAND, MAIER & NEUSTADT, P.C., 1940 DUKE STREET, ALEXANDRIA, VA, 22314, US

(73) Assignee: BASF Aktiengesellschaft, Ludwigshafen (DE)

(21) Appl. No.: 10/530,560

(22) PCT Filed: Oct. 6, 2003
(86) PCT No.: PCT/EP03/11012

§ 371 Date: Apr. 7, 2005

(51) Int. Cl. B27N 3/08; B29C 41/22

(52) U.S. Cl. 264/78; 264/112

(57) ABSTRACT

A process for producing colored oriented strand board, which comprises the wood strands which serve as a base material for oriented strand board being contacted, before or after-drying, with a liquid colorant preparation, then conventionally resinated, and formed into three-layered mats and these three-layered mats being hot-pressed into board having a center layer and two outside layers.

The present invention relates to a novel process for producing colored oriented strand board (OSB).

The OSB market is on the up in the sector of woodbase materials. OSB has hitherto mainly been used in the building and packaging sectors. Owing to its attractive surface structure, which is characterized by the orientation of the coarse wood fiber strands, OSB is increasingly being used in the decorative sector, for example in exhibition stands and also for floors and furniture. It would be desirable for these applications to have colored OSB available as well.

The first step in the OSB manufacturing process is the production of strands, which are dried in continuous dryers. Before or after drying, the strands are divided into two fractions (center layer and outside layer), which are separately resinated in drum mixers. The binders used in resination are amino resins (urea- or urea-melamine-formaldehyde resins) or, especially for the center layer, isocyanates (MDI: diphenylmethane 4,4′-diisocyanate). The resinated strands are formed in specific pourers into three-layered mats in which center and outside layer strands are ideally cross-directional. The formed mats are then pressed in continuous or batch hot presses at from 180 to 230° C. into OSB panels or ribbons.

Existing processes for coloring OSB, in which the colorant is applied to the strands in the course of resination together with the binders or separately therefrom, lead only to moderate success, since only dot-colored board is obtained.

It is an object of the present invention to develop a process whereby OSB can be colored very uniformly, although the typical “wood structure” shall remain visible at the same time.

We have found that this object is achieved by a process for producing colored oriented strand board, which comprises the wood strands which serve as a base material for oriented strand board being contacted, before or after drying, with a liquid colorant preparation, then conventionally resinated, and formed into three-layered mats and these three-layered mats being hot-pressed into board having a center layer and two outside layers.

The strands are preferably colored according to the present invention continually by spraying or dipping into the colorant solution or dispersion.

There is the option of coloring just the strands for one or both of the outside layers, just the strands for the center layer or the strands for all three layers. When more than one layer is colored, the hues for the individual layers may be chosen to be the same or different.

The key to the process of the present invention is that, contrary to the otherwise customary practice for the coloration of woodbase materials, where coloration and resination take place concurrently, the coloration of the strands is carried out prior to resination. This produces uniformly and intensively colored oriented strand board.

The liquid colorant preparation used in the process of the present invention may be an all pigment preparation, an all dye preparation or a preparation that includes both pigment and dye.

Preferably, preparations including both pigment and dye are used, since they produce particularly strong, brilliant and lightfast colorations. Particular preference is given in this connection to the preparations which have a dye content in the range from 0.5% to 10% by weight, based on the pigment.

The colorant preparations which are preferred according to the present invention typically include (A) at least one pigment, (B) at least one dye, (C) at least one dispersant and (D) water or a mixture of water and at least one water retainer.

The straight pigment or dye preparations which may likewise be used according to the present invention generally likewise include these constituents, although the dispersant (C) is dispensable especially for dye preparations in which the dye is present in solution.

Component (A) in the colorant preparations preferred according to this invention may be organic or inorganic pigments. It will be appreciated that the colorant preparations may also include mixtures of various organic or various inorganic pigments or mixtures of organic and inorganic pigments.

The pigments are preferably present in finely divided form. Accordingly, the pigments typically have average particle sizes from 0.1 to 5 μm, especially from 0.1 to 3 μm and in particular from 0.1 to 1 μm.

The organic pigments are typically organic chromatic and black pigments. Inorganic pigments can likewise be color pigments (chromatic, black and white pigments) and also luster pigments.

There now follow examples of suitable organic color pigments:
monoazo pigments:
   C.I. Pigment Brown 25;
   C.I. Pigment Orange 5, 13, 36, 64 and 67;
   C.I. Pigment Red 1, 2, 3, 4, 5, 8, 9, 12, 17, 22, 23, 31, 48:1, 48:2, 48:3, 48:4, 49, 49:1, 51:1, 52:1, 52:2, 53, 53:1, 53:3, 57:1, 58:2, 58:4, 63, 112, 146, 148, 170, 175, 184, 185, 187, 191:1, 208, 210, 245, 247 and 251;
   C.I. Pigment Yellow 1, 3, 62, 65, 73, 74, 97, 120, 151, 154, 168, 181, 183 and 191;
   C.I. Pigment Violet 32;
disazo pigments:
   C.I. Pigment Orange 16, 34, 44 and 72;
   C.I. Pigment Yellow 12, 13, 14, 16, 17, 81, 83, 106, 113, 126, 127, 155, 174, 176, 180 and 188;
disazo condensation pigments:
   C.I. Pigment Yellow 93, 95 and 128;
   C.I. Pigment Red 144, 166, 214, 220, 242 and 262;
   C.I. Pigment Brown 23 and 41;
anthanthrone pigments:
   C.I. Pigment Red 168;
anthraquinone pigments:
   C.I. Pigment Yellow 147, 177 and 199;
   C.I. Pigment Violet 31;
anthrapyrimidine pigments:
   C.I. Pigment Yellow 108;
quinacridone pigments:
   C.I. Pigment Orange 48 and 49;
   C.I. Pigment Red 122, 202, 206 and 209;
   C.I. Pigment Violet 19;
quinophthalone pigments:
   C.I. Pigment Yellow 138;
diketopyrrolopyrrole pigments:
   C.I. Pigment Orange 71, 73 and 81;
   C.I. Pigment Red 254, 255, 264, 270 and 272;
dioxazine pigments:
   C.I. Pigment Violet 23 and 37;
   C.I. Pigment Blue 80;
flavanthrone pigments:
   C.I. Pigment Yellow 24;
indanthrone pigments:
   C.I. Pigment Blue 60 and 64;
isoindoline pigments:
   C.I. Pigments Orange 61 and 69;
   C.I. Pigment Red 260;
   C.I. Pigment Yellow 139 and 185;
isoindolinone pigments:
   C.I. Pigment Yellow 109, 110 and 173;
isoviolanthrone pigments:
   C.I. Pigment Violet 31;
metal complex pigments:
   C.I. Pigment Red 257;
   C.I. Pigment Yellow 117, 129, 150, 153 and 177;
   C.I. Pigment Green 8;
perinone pigments:
   C.I. Pigment Orange 43;
   C.I. Pigment Red 194;
perylene pigments:
   C.I. Pigment Black 31 and 32;
   C.I. Pigment Red 123, 149, 178, 179, 190 and 224;
   C.I. Pigment Violet 29;
phthalocyanine pigments:
   C.I. Pigment Blue 15, 15:1, 15:2, 15:3, 15:4, 15:6 and 16;
   C.I. Pigment Green 7 and 36;
pyranthrone pigments:
   C.I. Pigment Orange 51;
   C.I. Pigment Red 216;
pyrazoloquinazolone pigments:
   C.I. Pigment Orange 67;
   C.I. Pigment Red 251;
thioindigo pigments:
   C.I. Pigment Red 88 and 181;
   C.I. Pigment Violet 38;
triarylcarbonium pigments:
   C.I. Pigment Blue 1, 61 and 62;
   C.I. Pigment Green 1;
   C.I. Pigment Red 81, 81:1 and 169;
   C.I. Pigment Violet 1, 2, 3 and 27;
C.I. Pigment Black 1 (aniline black);
C.I. Pigment Yellow 101 (aldazine yellow);
C.I. Pigment Brown 22.
   Examples of suitable inorganic color pigments are:
white pigments:
   titanium dioxide (C.I. Pigment White 6), zinc white, pigment grade zinc oxide;
   zinc sulfide, lithopone;
black pigments:
   iron oxide black (C.I. Pigment Black 11),
   iron manganese black, spinel black (C.I. Pigment Black 27); carbon black (C.I. Pigment Black 7);
chromatic pigments:
   chromium oxide, chromium oxide hydrate green; chrome green (C.I. Pigment Green 48); cobalt green (C.I. Pigment Green 50); ultramarine green;
   cobalt blue (C.I. Pigment Blue 28 and 36; C.I. Pigment Blue 72); ultramarine blue; manganese blue;
   ultramarine violet; cobalt violet and manganese violet;
   red iron oxide (C.I. Pigment Red 101);
   cadmium sulfoselenide (C.I. Pigment Red 108); cerium sulfide (C.I. Pigment Red 265); molybdate red (C.I. Pigment Red 104); ultramarine red;
   brown iron oxide (C.I. Pigment Brown 6 and 7), mixed brown, spinel phases and corundum phases (C.I. Pigment Brown 29, 31, 33, 34, 35, 37, 39 and 40), chromium titanium yellow (C.I. Pigment Brown 24), chrome orange;
   cerium sulfide (C.I. Pigment Orange 75);
   yellow iron oxide (C.I. Pigment Yellow 42); nickel titanium yellow (C.I. Pigment Yellow 53; C.I. Pigment Yellow 157, 158, 159, 160, 161, 162, 163, 164 and 189); chromium titanium yellow; spinel phases (C.I. Pigment Yellow 119); cadmium sulfide and cadmium zinc sulfide (C.I. Pigment Yellow 37 and 35); chrome yellow (C.I. Pigment Yellow 34); bismuth vanadate (C.I. Pigment Yellow 184).

Luster pigments are platelet-shaped pigments having a monophasic or polyphasic construction whose color play is marked by the interplay of interference, reflection and absorption phenomena. Examples are aluminum platelets and aluminum, iron oxide and mica platelets bearing one or more coats, especially of metal oxides.

The amount of pigment (A) included in the colorant preparations preferredly used according to this invention is generally in the range from 10% to 70% by weight and preferably in the range from 10% to 60% by weight.

Component (B) in the colorant preparations preferred according to this invention is at least one dye. Dyes which are suitable are in particular dyes which are soluble in water or in a water-miscible or water-soluble organic solvent. Preferably, the dyes (B) used have in each case a hue which is comparable to the pigments (A), since this is a way of achieving a particularly intensive coloration of the woodbase materials. However, it is also possible to use dyes (B) which differ in hue, thereby enabling the coloration to be shaded.

Suitable dyes are in particular cationic and anionic dyes, of which cationic dyes are preferred.

Suitable cationic dyes (B) belong in particular to the di- and triarylmethane, xanthene, azo, cyanine, azacyanine, methine, acridine, safranine, oxazine, induline, nigrosine and phenazine range, and dyes of the azo, triarylmethane and xanthene range are preferred.

Specific examples which may be recited are: C.I. Basic Yellow 1, 2 and 37; C.I. Basic Orange 2; C.I. Basic Red 1 and 108; C.I. Basic Blue 1, 7 and 26; C.I. Basic Violet 1, 3, 4, 10, 11 and 49; C.I. Basic Green 1 and 4; C.I. Basic Brown 1 and 4.

Cationic dyes (B) may also be colorants containing external basic groups. Suitable examples here are C.I. Basic Blue 15 and 161.

Useful cationic dyes (B) further include the corresponding dyebases used in the presence of solubilizing acidic agents. As examples there may be mentioned: C.I. Solvent Yellow 34; C.I. Solvent Orange 3; C.I. Solvent Red 49; C.I. Solvent Violet 8 and 9; C.I. Solvent Blue 2 and 4; C.I. Solvent Black 7.

Suitable anionic dyes are in particular sulfo-containing compounds from the range of the azo, anthraquinone, metal complex, triarylmethane, xanthene and stilbene dyes, and dyes of the triarylmethane, azo and metal complex (especially copper, chromium and cobalt complex) range are preferred.

Specific examples which may be mentioned are: C.I. Acid Yellow 3, 19, 36 and 204; C.I. Acid Orange 7, 8 and 142; C.I. Acid Red 52, 88, 351 and 357; C.I. Acid Violet 17 and 90; C.I. Acid Blue 9, 193 and 199; C.I. Acid Black 194; anionic chromium complex dyes such as C.I. Acid Violet 46, 56, 58 and 65; C.I. Acid Yellow 59; C.I. Acid Orange 44, 74 and 92; C.I. Acid Red 195; C.I. Acid Brown 355 and C.I. Acid Black 52; anionic cobalt complex dyes such as C.I. Acid Yellow 119 and 204, C.I. Direct Red 80 and 81.

Preference is given to water-soluble dyes.

As water-solubilizing cations there may be mentioned in particular alkali metal cations, such as Li⁺, Na⁺, K⁺, ammonium and substituted ammonium ions, especially alkanolammonium ions.

The amount in which dye (B) is included in the colorant preparations preferredly used according to this invention is generally in the range from 0.5% to 10% by weight and preferably in the range from 1% to 8% by weight, each percentage being based on the pigment (A). Based on the total weight of the preparation, this corresponds to amounts of generally from 0.05% to 7% by weight and in particular from 0.1% to 5.6% by weight.

Preferred pigment-dye combinations are for example: C.I. Pigment Blue 15:1. and C.I. Basic Violet 4; C.I. Pigment Green 7 and C.I. Basic Green 4; C.I. Pigment Red 48:2 and C.I. Direct Red 80; C.I. Pigment Black 7 and C.I. Basic Violet 3.

Component (C) in the colorant preparations to be used according to this invention is at least one dispersant.

Particularly suitable dispersants (C) are nonionic and anionic surface-active additives and also mixtures thereof.

Preferred nonionic surface-active additives (C) are based on polyethers in particular.

As well as unmixed polyalkylene oxides, preferably C₂-C₄-alkylene oxides and phenyl-substituted C₂-C₄-alkylene oxides, especially polyethylene oxides, polypropylene oxides and poly(phenylethylene oxide)s, it is in particular block copolymers, especially polymers which contain polypropylene oxide and polyethylene oxide blocks or poly(phenylethylene oxide) and polyethylene oxide blocks, and also random copolymers of these alkylene oxides which are suitable.

These polyalkylene oxides are preparable by polyaddition of the alkylene oxides to starter molecules, as to saturated or unsaturated aliphatic and aromatic alcohols, to phenol or naphthol, which may each be substituted by alkyl, especially C₁-C₁₂-alkyl, preferably C₄-C₁₂-alkyl and C₁-C₄-alkyl respectively, to saturated or unsaturated aliphatic and aromatic amines and to saturated or unsaturated aliphatic carboxylic acids and carboxamides. It is customary to use from 1 to 300 mol and preferably from 3 to 150 mol of alkylene oxide per mole of starter molecule.

Suitable aliphatic alcohols contain in general from 6 to 26 carbon atoms and preferably from 8 to 18 carbon atoms and can have an unbranched, branched or cyclic structure. Examples are octanol, nonanol, decanol, isodecanol, undecanol, dodecanol, 2-butyloctanol, tridecanol, isotridecanol, tetradecanol, pentadecanol, hexadecanol (cetyl alcohol), 2-hexyldecanol, heptadecanol, octadecanol (stearyl alcohol), 2-heptylundecanol, 2-octyldecanol, 2-nonyltridecanol, 2-decyltetradecanol, oleyl alcohol and 9-octadecenol and also mixtures of these alcohols, such as C₈/C₁₀, C₁₃/C₁₅ and C₁₆/C₁₈ alcohols, and cyclopentanol and cyclohexanol. Of particular interest are the saturated or unsaturated fatty alcohols obtained from natural raw materials by fat hydrolysis and reduction and the synthetic fatty alcohols from the oxo process. The alkylene oxide adducts with these alcohols typically have average molecular weights Mₙ from 200 to 5 000.

Examples of the abovementioned aromatic alcohols include not only unsubstituted phenol and α- and β-naphthol but also hexylphenol, heptylphenol, octylphenol, nonylphenol, isononylphenol, undecylphenol, dodecylphenol, di- and tributylphenol and dinonylphenol.

Suitable aliphatic amines correspond to the abovementioned aliphatic alcohols. Again of particular importance here are the saturated and unsaturated fatty amines which preferably have from 14 to 20 carbon atoms. Examples of suitable aromatic amines are aniline and its derivatives.

Useful aliphatic carboxylic acids include especially saturated and unsaturated fatty acids which preferably contain from 14 to 20 carbon atoms and fully hydrogenated, partially hydrogenated and unhydrogenated resin acids and also polyfunctional carboxylic acids, for example dicarboxylic acids, such as maleic acid.

Suitable carboxamides are derived from these carboxylic acids.

As well as alkylene oxide adducts with monofunctional amines and alcohols it is alkylene oxide adducts with at least bifunctional amines and alcohols which are of very particular interest.

The at least bifunctional amines preferably have from 2 to 5 amine groups and conform in particular to the formula H₂N-(R-NR¹)ₙ-H (R: C₂-C₆-alkylene; R¹: hydrogen or C₁-C₆-alkyl; n: 1-5). Specific examples are: ethylenediamine, diethylenetriamine, triethylenetetramine, tetraethylenepentamine, 1,3-propylenediamine, dipropylenetriamine, 3-amino-1-ethyleneaminopropane, hexamethylenediamine, dihexamethylenetriamine, 1,6-bis(3-amino-propylamino) hexane and N-methyldipropylenetriamine, of which hexamethylenediamine and diethylenetriamine are more preferable and ethylenediamine is most preferable.

These amines are preferably reacted first with propylene oxide and then with ethylene oxide. The ethylene oxide content of the block copolymers is typically about 10-90% by weight.

The average molecular weights Mₙ of the block copolymers based on polyamines are generally in the range from 1 000 to 40 000 and preferably in the range from 1 500 to 30 000.

The at least bifunctional alcohols preferably have from two to five hydroxyl groups. Examples are C₂-C₆-alkylene glycols and the corresponding di- and polyalkylene glycols, such as ethylene glycol, 1,2-propylene glycol, 1,3-propylene glycol, 1,2-butylene glycol, 1,4-butylene glycol, 1,6-hexylene glycol, dipropylene glycol and polyethylene glycol, glycerol and pentaerythritol, of which ethylene glycol and polyethylene glycol are more preferable and propylene glycol and dipropylene glycol are most preferable.

Particularly preferred alkylene oxide adducts with at least bifunctional alcohols have a central polypropylene oxide block, ie are based on a propylene glycol or polypropylene glycol which is initially reacted with further propylene oxide and then with ethylene oxide. The ethylene oxide content of the block copolymers is typically in the range from 10% to 90% by weight.

The average molecular weights Mₙ of the block copolymers based on polyhydric alcohols are generally in the range from 1 000 to 20 000 and preferably in the range from 1 000 to 15 000.

Such alkylene oxide block copolymers are known and commercially obtainable, for example under the names Tetronic® and Pluronic® (BASF).

Anionic surface-active additives (C) are based in particular on sulfonates, sulfates, phosphonates or phosphates and also on surface-achive polymers containing carboxylate groups.

Examples of suitable sulfonates are aromatic sulfonates, such as p-C₈-C₂₀-alkylbenzenesulfonates, di(C₁-C₈-alkyl)naphthalenesulfonates and condensation products of naphthalenesulfonic acids with formaldehyde, and aliphatic sulfonates, such as C₁₂-C₁₈-alkanesulfonates, α-sulfo fatty acid C₂-C₈-alkyl esters, sulfosuccinic esters and alkoxy-, acyloxy- and acylaminoalkanesulfonates.

Preference is given to aryl sulfonates, and the di(C₁-C₈-alkyl) naphthalenesulfonates are particularly preferred. Diisobutyl- and diisopropylnaphthalenesulfonates are very particularly preferred.

Examples of suitable sulfates are C₈-C₂₀-alkyl sulfates.

A further important group of anionic surface-active additives (C) is formed by the sulfonates, sulfates, phosphonates and phosphates of the polyethers mentioned as nonionic additives.

Reaction with phosphoric acid, phosphorus pentoxide and phosphonic acid on the one hand or with sulfuric acid and sulfonic acid on the other converts these into the phosphoric mono- or diesters and phosphonic esters on the one hand and the sulfuric monoesters and sulfonic esters on the other. Like the sulfonates and sulfates recited earlier, these acid esters are preferably in the form of water-soluble salts, especially as alkali metal salts, in particular sodium salts, and ammonium salts, but can also be used in the form of the free acids.

Preferred phosphates and phosphonates are derived in particular from alkoxylated and especially ethoxylated fatty and oxo process alcohols, alkylphenols, fatty amines, fatty acids and resin acids, while preferred sulfates and sulfonates are based in particular on alkoxylated and especially ethoxylated fatty alcohols, alkylphenols and amines, including polyfunctional amines, such as hexamethylenediamine

Such anionic surface-active additives are known and commercially available for example under the names of Nekal® (BASF), Tamol® (BASF), Crodafos® (Croda), Rhodafac® (Rhodia), Maphos® (BASF), Texapon® (Cognis), Empicol® (Albright & Wilson), Matexil® (ICI), Soprophor® (Rhodia) and Lutensit® (BASF).

Suitable anionic surface-active additives (C) are further based on water-soluble polymers which contain carboxylate groups. These may be advantageously adapted to the respective application and the respective pigment by adjusting the ratio between polar and apolar moieties.

Monomers used for preparing these additives are in particular ethylenically unsaturated monocarboxylic acids, ethylenically unsaturated dicarboxylic acids and also vinyl derivatives without an acid function.

Examples which may be mentioned of these monomer groups are:
acrylic acid, methacrylic acid and crotonic acid;
maleic acid, maleic anhydride, maleic monoesters, maleic monoamides, reaction products of maleic acid with diamines that may have been oxidized to derivatives containing amine oxide groups, and fumaric acid, of which maleic acid, maleic anhydride and maleic monoamides are preferred;
styrenics, such as styrene, methylstyrene and vinyltoluene; ethylene, propylene, isobutene; vinyl esters of linear or branched monocarboxylic acids, such as vinyl acetate and vinyl propionate; alkyl esters and aryl esters of ethylenically unsaturated monocarboxylic acids, especially acrylic and methacrylic esters, such as methyl, ethyl, propyl, isopropyl, butyl, pentyl, hexyl, 2-ethylhexyl, nonyl, lauryl and hydroxyethyl (meth)acrylates and also phenyl, naphthyl and benzyl (meth)acrylates; dialkyl esters of ethylenically unsaturated dicarboxylic acids, such as dimethyl, diethyl, dipropyl, diisopropyl, dibutyl, dipentyl, dihexyl, di-2-ethylhexyl, dinonyl, dilauryl and di-2-hydroxyethyl maleates and fumarates; vinylpyrrolidone; acrylonitrile and methacrylonitrile, of which styrene is preferred.

As well as homopolymers of these monomers, especially polyacrylic acids, it is in particular copolymers of the monomers mentioned that are useful as an additive (C). The copolymers may be random copolymers, block copolymers and graft copolymers.

Preferably, the carboxyl groups of the polymeric additives (C) are at least partly present in salt form in order that solubility in water may be ensured. Suitable examples are alkali metal salts, such as sodium and potassium salts, and ammonium salts.

The average molecular weight M_{w} of the polymeric additives (C) is typically in the range from 1 000 to 250 000 and the acid number is generally in the range from 40 to 800.

Examples of preferred polymeric additives (C) are polyacrylic acids and also styrene-acrylic acid, acrylic acid-maleic acid, butadiene-acrylic acid and styrene-maleic acid copolymers, which may each contain acrylic esters and/or maleic esters as additional monomer constituents.

Particularly preferred polymeric additives (C) are polyacrylic acids, which generally have average molecular weights M_{w} in the range from 1 000 to 250 000 and acid numbers of ≧200, and styrene-acrylic acid copolymers, which generally have an average molecular weight M_{w} in the range from 1 000 to 50 000 and acid numbers of ≧50.

Such anionic surface-active additives are likewise known and commercially available, for example under the names of Sokalan® (BASF), Joncryl® (Johnson Polymer), Neoresin® (Avecia) and also Orotan® and Morez® (Rohm & Haas).

The amount of dispersant (C) in the colorant preparations preferredly used according to this invention is typically in the range from 1% to 50% by weight and especially in the range from 1% to 40% by weight.

Water forms the liquid vehicle for the colorant preparations that are used according to this invention.

The liquid phase of the colorant preparations is preferably a mixture of water and a water retainer. The water retainers used are in particular organic solvents which are high boiling (ie generally have a boiling point >100° C.) and hence have a water-retaining action and are soluble in or miscible with water.

Example of suitable water retainers are polyhydric alcohols, preferably unbranched and branched polyhydric alcohols containing from 2 to 8 and especially from 3 to 6 carbon atoms, such as ethylene glycol, 1,2-propylene glycol, 1,3-propylene glycol, glycerol, erythritol, pentaerythritol, pentitols, such as arabitol, adonitol and xylitol and hexitols such as sorbitol, mannitol and dulcitol. Useful water retainers further include for example di-, tri- and tetraalkylene glycols and their monoalkyl (especially C₁-C₆-alkyl and in particular C₁-C₄-alkyl) ethers. Examples which may be mentioned are di-, tri- and tetraethylene glycol, diethylene glycol monomethyl, monoethyl, monopropyl and monobutyl ethers, triethylene glycol monomethyl, monoethyl, monopropyl and monobutyl ethers, di-, tri- and tetra-1,2- and -1,3-propylene glycol and di-, tri- and tetra-1,2- and -1,3-propylene glycol monomethyl, monoethyl, monopropyl and monobutyl ethers.

The amount of liquid phase (D) present in the colorant preparations preferredly used according to this invention is generally in the range from 10% to 88.95% by weight and preferably in the range from 10% to 80% by weight. When water is present in a mixture with a water-retaining organic solvent, this solvent will account for a proportion of phase (D) which is generally in the range from 1% to 80% by weight and preferably in the range from 1% to 60% by weight.

The colorant preparations may further contain customary addition agents, such as biocides, defoamers, antisettling agents and rheological modifiers, whose fraction may generally be up to 5% by weight.

The colorant preparations which are preferred according to the present invention, which include both pigment and dye, are obtainable in various ways. It is preferable first to prepare a pigment dispersion which is then admixed with the dye as a solid or especially in dissolved form.

### EXAMPLES

| 1. | Production of colorant preparations | |
|---|---|---|
| | The following colorant preparations were used for coloring | |
| | OSB. | |
| 1.1. | Green pigment preparation | |
| | Mixture prepared by wet grinding of | |
| | 40% by weight of | C.I. Pigment Green 7 |
| | 8% by weight of | a block copolymer based on |
| | | ethylenediamine/propylene |
| | | oxide/ethylene oxide and having |
| | | an ethylene oxide content of 40% |
| | | by weight and an average molecular |
| | | weight Mₙ of 6500 |
| | 15% by weight of | dipropylene glycol |
| | 37% by weight of | water |
| | in a stirred ball mill. | |
| 1.2. | Red pigment preparation | |
| | Mixture obtained by wet grinding in a stirred ball mill | |
| | from | |
| | 30% by weight of | C.I. Pigment Red 48:2 |
| | 29% by weight of | a 26% by weight ammoniacal solution |
| | | of an acrylic acid/styrene copolymers |
| | | having an acid number of 216 mg KOH/g |
| | | and an average molecular weight |
| | | Mₙ of 9200 |
| | 1% by weight of | dipropylene glycol |
| | 40% by weight of | water. |
| 1.3. | Black pigment preparation | |
| | Mixture obtained by wet grinding | |
| | 40% by weight of | C.I. Pigment Black 7 |
| | 10% by weight of | a block copolymer based on |
| | | ethylenediamine/propylene |
| | | oxide/ethylene oxide and having |
| | | an ethylene oxide content of 40% |
| | | by weight and an average molecular |
| | | weight Mₙ of 12000 |
| | 22% by weight of | dipropylene glycol |
| | 28% by weight of | water |
| | in a stirred ball mill. | |
| 1.4. | Blue pigment preparation | |
| | Mixture obtained by wet grinding | |
| | 40% by weight of | C.I. Pigment Blue 15:1 |
| | 8% by weight of | a block copolymers based on |
| | | ethylenediamine/propylene oxide/ |
| | | ethylene oxide and having an |
| | | ethylene oxide content of 40% by |
| | | weight and an average molecular |
| | | weight Mₙ of 6700 |
| | 10% by weight of | dipropylene glycol |
| | 42% by weingt of | water |
| | in a stirred ball mill. | |
| 1.5. | Green colorant preparation | |
| | Mixture composed of 25% by weight of the green pigment | |
| | preparation No. 1.1 and 7% by weight of a 47% by weight | |
| | solution of C.I. Basic Green 7 in 48% by weight acetic | |
| | acid and also 68% by weight of water. | |
| 1.6. | Red colorant preparation | |
| | Mixture obtained by wet grinding in a stirred ball mill | |
| | from | |
| | 26% by weight of | C.I. Pigment Red 48:2 |
| | 5% by weight of | C.I. Direct Red 80 |
| | 24% by weight of | a 26% by weight ammoniacal |
| | | solution of an acrylic acid/ |
| | | styrene copolymer having an |
| | | acid number of 216 mg KOH/g |
| | | and an average molecular |
| | | weight Mₙ of 9200 |
| | 5% by weight of | dipropylene glycol |
| | 40% by weight of | water. |

| | |
|---|---|
| 1.7. | Black colorant preparation |
| | Mixture composed of 94% by weight of the black pigment |
| | preparation No. 1.3 and 6% by weight of a 10% by weight |
| | solution of C.I. Basic Violet 3 in 30% by weight acetic |
| | acid. |
| 1.8. | Blue colorant preparation |
| | Mixture composed of 90% by weight of the blue pigment |
| | preparation No. 1.4 and 10% by weight of a 10% by weight |
| | solution of C.I. Basic Violet 4 in 30% by weight acetic |
| | acid. |
| 1.9. | Violet dye preparation |
| | 10% by weight solution of C.I. Basic Violet 4 in 30% by |
| | weight acetic acid. |
| 1.10. | Green dye preparation |
| | 47% by weight solution of C.I. Basic Green 4 in 48% by |
| | weight acetic acid. |
| 2. | Production of colored OSB |

OSB was produced using the resin batch recited in the following table:

TABLE

| | | |
|---|---|---|
| | Center | Outside |
| Resin batch for | layer strands | layer strands |

| | | | | |
|---|---|---|---|---|
| Urea-melamine- | 100.0 | parts | 100.0 | parts |
| formaldehyde | | by weight | | by weight |
| resin, 65% by | | | | |
| weight in water | | | | |
| Paraffin | 14.8 | parts | 14.8 | parts |
| dispersion, | | by weight | | by weight |
| 60% by weight | | | | |
| in water | | | | |
| Ammonium sulfate | 10.0 | parts | 4.0 | parts |
| solution, 20% by | | by weight | | by weight. |
| weight in water | | | | |
| Water | 5.2 | parts by | 11.2 | parts |
| | | weight | | by weight |
| Resin solids | 50% | by weight | 50% | by weight |
| content of | | | | |
| liquor | | | | |
| Resin solids/ | 11.0% | by weight | 11.0% | by weight |
| bone-dry | | | | |
| strands | | | | |
| Solid wax/ | 1.5% | by weight | 1.5% | by weight |
| bone-dry | | | | |
| strands | | | | |

2.1. Production of Green OSB

The strands were colored by spraying with a 0.5% by weight dispersion of pigment preparation No. 1.1 in water before drying and dried in drum dryers to a moisture content of 1-2% by weight.

Thereafter, the colored strands were divided into center and outside layer fractions and resinated in separate continuous mixers with the resin batches mentioned in the table.

The resinated strands were conventionally formed into mats and pressed at 200° C. into board.

The OSB obtained exhibited a homogeneous, intensive green color. The wood structure was visible after sanding.

2.2 Production of Red OSB Having an Isocyanate-bound Center Layer

The strands were colored with a 0.2% by weight dispersion of pigment preparation No. 1.2 in water by dipping before drying and dried in drum dryers to a moisture content of 1-2% by weight.

The colored strands were then divided into center and outside layer fractions and resinated in separate continuous mixers. The strands for the outside layer were resinated using the resin batch mentioned in the table. The strands for the center layer were resinated with 4% by weight of isocyanate (MDI) which was emulsified in water (weight ratio 1:1) immediately before resination.

The resinated strands were conventionally formed into mats and pressed at 200° C. into board.

The OSB obtained exhibited a homogeneous, intensive red color. The wood structure was visible after sanding.

2.3. Production of Black OSB Having an Isocyanate-bound Center Layer

The strands were colored with a 5% by weight dispersion of colorant preparation No. 1.3 in water by dipping before drying and dried in drum dryers to a moisture content of 1-3% by weight.

The colored strands were then divided into center and outside layer fractions and resinated in separate continuous mixers. The strands for the outside layer were resinated using the resin batch mentioned in the table. The strands for the center layer were resinated with 4% by weight of isocyanate (MDI) which was emulsified in water (weight ratio 1:1) immediately before resination.

The resinated strands were conventionally formed into mats and pressed at 200° C. into board.

The OSB obtained exhibited a homogeneous, intensive brilliant black color. The wood structure was visible after sanding.

2.4. Production of Blue OSB

The strands were colored by dipping with a 0.5% by weight dispersion of dye preparation No. 1.4 in water before drying and dried in drum dryers to a moisture content of 1-2% by weight.

Thereafter, the colored strands were divided into center and outside layer fractions and resinated in separate continuous mixers with the resin batches mentioned in the table.

The resinated strands were conventionally formed into mats and pressed at 200° C. into board.

The OSB obtained exhibited a homogeneous, intensive blue color. The wood structure was visible after sanding.

2.5 Production of Green OSB

The strands were colored by dipping with a 0.6% by weight dispersion of pigment preparation No. 1.5 in water before drying and dried in drum dryers to a moisture content of 1-2% by weight.

Thereafter, the colored strands were divided into center and outside layer fractions and resinated in separate continuous mixers with the resin batches mentioned in the table.

The resinated strands were conventionally formed into mats and pressed at 200° C. into board.

The OSB obtained exhibited a homogeneous, intensive green color. The wood structure was visible after sanding.

2.6 Production of OSB Having Red Outside Layers and an Isocyanate-bound Center Layer

The dried strands were divided into center and outside layer fractions.

The strands for the outside layer were colored with a 5% by weight dispersion of colorant preparation No. 1.6 in water by dipping and subsequently resinated with the resin batch mentioned in the table for the outside layer.

The strands for the center layer were resinated with 4% by weight of isocyanate (MDI) which was emulsified in water (weight ratio 1:1) immediately before resination.

The resinated strands were conventionally formed into mats and pressed at 200° C. into board.

The OSB obtained exhibited a homogeneous, intensive, brilliant red color in the outside layer. The wood structure was visible after sanding.

2.7 Production of Black OSB

The strands were colored by dipping with a 3% by weight solution of dye preparation No. 1.7 in water before drying and dried in drum dryers to a moisture content of 1-2% by weight.

Thereafter, the colored strands were divided into center and outside layer fractions and resinated in separate continuous mixers with the resin batches mentioned in the table.

The resinated strands were conventionally formed into mats and pressed at 200° C. into board.

The OSB obtained exhibited a homogeneous, intensive black color. The wood structure was visible after sanding.

2.8 Production of OSB Having Blue Outside Layers and an Isocyanate-bound Center Layer

The dried strands were divided into center and outside layer fractions.

The strands for the outside layer were colored with a 5% by weight dispersion of colorant preparation No.. 1.8 in water by dipping and subsequently resinated with the resin batch mentioned in the table for the outside layer.

The strands for the center layer were resinated with 4% by weight of isocyanate (MDI) which was emulsified in water (weight ratio 1:1) immediately before resination.

The resinated strands were conventionally formed into mats and pressed at 200° C. into board.

The OSB obtained exhibited a homogeneous, intensive, brilliant blue color in the outside layer. The wood structure was visible after sanding.

2.9 Production of Violet OSB

The strands were colored by spraying with a 0.3% by weight dispersion of pigment preparation No. 1.9 in water before drying and dried in drum dryers to a moisture content of 1-2% by weight.

Thereafter, the colored strands were divided into center and outside layer fractions and resinated in separate continuous mixers with the resin batches mentioned in the table.

The resinated strands were conventionally formed into mats and pressed at 200° C. into board.

The OSB obtained exhibited a homogeneous, intensive violet color. The wood structure was visible after sanding.

2.10 Production of OSB Having Green Outside Layers and an Isocyanate-bound Center Layer

The dried strands were divided into center and outside layer fractions.

The strands for the outside layer were colored with a 5% by weight dispersion of colorant preparation No. 1.10 in water by dipping and subsequently resinated with the resin batch mentioned in the table for the outside layer.

The strands for the center layer were resinated with 4% by weight of isocyanate (MDI) which was emulsified in water (weight ratio 1:1) immediately before resination.

The resinated strands were conventionally formed into mats and pressed at 200° C. into board.

The OSB obtained exhibited a homogeneous, intensive, brilliant green color in the outside layer. The wood structure was visible after sanding.

1-9. (canceled)

10. A process for producing a colored, oriented strand board comprising:
contacting the wood strands which serve as a base material for at least one of the three layers of the oriented strand board with a liquid colorant preparation which comprises at least one pigment and at least one dye;
resinating and forming said wood strands into a three-layered mat; and
hot-pressing said three-layered mat into said colored, oriented strand board comprising a center layer and two outside layers, wherein said wood strands serve as a base material for said colored, oriented strand board.

11. The process of claim 10, wherein said contacting occurs before said wood strands are dried.

12. The process of claim 10, wherein said contacting occurs after said wood strands are dried.

13. The process of claim 10, wherein said hot-pressing is conducted at a temperature of from 180 to 230° C.

14. The process of claim 10, wherein said wood strands are continually colored by spraying or dipping into a colorant solution or a dispersion.

15. The process of claim 10, wherein said liquid colorant preparation comprises from 0.5% to 10% by weight of said dye based on said pigment.

16. The process of claim 10, wherein only one outside layer is colored in said colored, oriented strand board.

17. The process of claim 10, wherein only both outside layers are colored in said colored, oriented strand board.

18. The process of claim 10, wherein only said center layer is colored in said colored, oriented strand board.

19. The process of claim 10, wherein both outside layers and said center layer are colored in said colored, oriented strand board.

20. The process of claim 10, wherein when at least two layers are colored in said colored, oriented strand board, said layers have different hues.

21. The process of claim 10, wherein when at least two layers are colored in said colored, oriented strand board, said layers have the same hue.

22. The process of claim 10, wherein said colorant preparation comprises:
(a) from 10% to 70% by weight of at least one pigment,
(b) from 0.05% to 7% by weight of at least one dye,
(c) from 1 to 50% by weight of at least one dispersant,
(d) from 10% to 88.95% by weight of water or of a mixture of water and at least one water retainer, and
(e) from 0% to 5% by weight of further customary constituents for colorant preparations.

23. The process of claim 22, wherein component (b) comprises at least one anionic or cationic dye.

24. The process of claim 22, wherein component (c) comprises at least one nonionic surface-active additive, at least one anionic surface-active additive, or a mixture thereof.

25. The process of claim 22, wherein said water retainer comprises a high-boiling organic solvent which is soluble in or miscible with water.

26. An oriented strand board colored with a colorant preparation which comprises at least one pigment and, based on the pigment, from 0.5% to 10% by weight of at least one dye.
